(19) United States
(12) Patent Application Publication
(10) Pub. No.: US 2026/0063475 A1
(43) Pub. Date: Mar. 5, 2026

(54) An Optical Perfect Matching Solver Based on Frequency Grouping and Multi-Photon Coincidence Counts

(71) Applicant: National University of Defense Technology, Changsha (CN)

(72) Inventors: Ping XU, changsha (CN); Pingyu ZHU, Changsha (CN); Kun WANG, Changsha (CN)

(73) Assignee: National University of Defense Technology, Changsha, CN (CN)

(21) Appl. No.: 18/882,616

(22) Filed: Sep. 11, 2024

(30) Foreign Application Priority Data
Sep. 2, 2024 (CN) 2024112196628

(51) Int. Cl. G01J 11/00; G01J 1/44

(52) U.S. Cl. CPC G01J 11/00; G01J 1/44; G01J 2001/442

(57) ABSTRACT

An optical perfect matching solver based on frequency grouping and multi-photon coincidence measurement comprises a broadband biphoton source, a wavelength selector, and a multi-photon coincidence detection system. The broadband biphoton source generates photon pairs using pulsed laser pumping in a nonlinear material with broadband phase matching. The wavelength selector, made up of a grating and a spatial light modulator, can combine any frequency component of the input light into a designated output port. The multi-photon coincidence detection system comprises single-photon detection channels and a coincidence counting logic circuit board, is used to measure multi-photon coincidence counts and distributions. The pulsed laser light source is firstly injected into the nonlinear material, where a broadband four-wave mixing effect occurs, generating frequency-correlated photon pairs; the wavelength selector groups and configure the photons into a specified graph; and multi-photon coincidence measurements are performed, and the output automatically retains the state with perfect matching characteristics.

### CROSS REFERENCE TO RELATED APPLICATION

This application claims priority to a Chinese Application No. 2024112196628, filed on Sep. 2, 2024. Both the Chinese applications are incorporated herein by reference in its entirety.

### TECHNICAL FIELD

This invention relates to the fields of graph theory, nonlinear optics, quantum optics, nonlinear materials, and optoelectronic technology. It provides an optical method for solving the distribution of perfect matchings in a graph.

### TECHNICAL BACKGROUND

Connections in the real world can be represented using graphs, such as social networks, molecular structures, and traffic interconnectivity. Perfect matching counting, as one of the well-known complex problems, has a wide range of applications. A perfect matching refers to a matching that covers all vertices in an undirected graph. The complexity of calculating the number of perfect matchings in a graph with a 0-1 symmetric adjacency matrix belongs to the #P-complete class, and there is no known polynomial-time exact algorithm to solve it.

Optical computing based on laser technology is expected to solve graphical problems faster than traditional electronic computers. Optical methods have been proposed to solve specific problems, such as the maximum cut problem, the maximum clique problem, the Hamiltonian path problem, and others, showing potential acceleration. Additionally, quantum multiphoton sources have unique properties that surpass classical light fields, and experiments require the use of multiphoton coincidence detection systems, which have been reported to solve problems such as maximum cliques, dense subgraphs, and perfect matchings. For the perfect matching problem, since the number of perfect matchings in an undirected graph equals the Hafnian of the graph's adjacency matrix, the number of perfect matchings can be estimated through Gaussian boson sampling with specific settings. Furthermore, the Hafnian can also be obtained from the multiphoton coincidences in cascaded nonlinear crystals using the path identity method. However, due to stringent coherence requirements, including high purity of the photon source, stability of the relative phase, and the identity of paths and arrival times, both methods face challenges in achieving large-scale photonic hardware.

Patent CN202311424576.6 discloses a quantum sensor resonance frequency evaluation system and method based on multiphoton excitation, including a detection laser module, coupling laser module, quantum sensor, quick measurement module, experimental signal source, and evaluation calculation module. The experimental signal source is set facing the quantum sensor to emit radiofrequency electromagnetic signals to the quantum sensor; the quantum sensor includes a sealed glass chamber containing alkali metal atomic vapor. The detection laser module is connected to one side of the quantum sensor, while the coupling laser module is connected to the opposite side of the quantum sensor via the quick measurement module. This invention features a simple structure, quick operation, high measurement efficiency, and provides a scientific and quantitative evaluation of the quantum sensor. However, it still does not solve the problems of existing technology.

Patent CN201811220744.9 describes a multiphoton coincidence counting method and device, which adopts a multi-phase clock TDC (Time-to-Digital Converter) and a digital window comparator to mark the time and perform coincidence detection on pulses across various channels in parallel. The coincidence results are then filtered in real-time to reduce the burden of subsequent data transmission, storage, and analysis. The design also includes channel scanning and real-time statistical analysis of some of the coincidence results. Most of these designs can be implemented within a single FPGA chip, supporting two-dimensional coincidence detection based on time and channels, with the number of channels supported reaching hundreds, offering good compatibility and scalability. Additionally, the relevant method time-stamps pulse edges using time measurement tools, defines the desired time windows for each channel, and then uses a window comparator to determine whether the pulse occurs within the defined time window. The results of all window comparators are recorded, obtaining coincidences across both time and channel dimensions.

The technical solution of this invention is as follows: an optical perfect matching solver based on frequency grouping and multi-photon coincidence detection, comprising a broadband biphoton source, a wavelength selector, and a multi-photon coincidence detection system. The broadband biphoton source can be generated by pumping pulsed laser light into a nonlinear material with broadband phase matching properties. The nonlinear material may comprises crystals (such as periodically poled lithium niobate, periodically poled potassium titanyl phosphate, etc.) and on-chip waveguides made of materials such as lithium niobate, silicon, and silicon nitride. The wavelength selector is comprised of a grating and a spatial light modulator, capable of combining arbitrary frequency components of the input light into designated output ports. The multi-photon coincidence detection system comprises of single-photon detection channels and a coincidence counting logic board for measuring multi-photon coincidence counts and distributions. Broadband photon pairs are generated using the nonlinear material, and the photons are grouped by the wavelength selector. According to different frequencies, the broadband frequency-entangled photon pairs are grouped into several outputs to configure a given graph.

The configuration follows these rules: each vertex of the graph corresponds to one output optical path, and each edge of the graph is represented by a pair of frequency-correlated biphotons that are grouped into the two output ports corresponding to the two vertices of the edge. The multi-photon coincidence detection output corresponds to the state where there is exactly one photon at each output, so the coincidence measurement will automatically retain the multi-photon states that conform to the perfect matching characteristics and filter out unwanted states, such as multiple photons arriving at the same output port. The multi-photon coincidence count will be directly proportional to the number of perfect matchings.

This invention provides a new optical method for solving the number of perfect matchings in graphs, featuring high stability, strong scalability, and flexible configuration.

Main content of the invention: Broadband photon pairs are generated using nonlinear materials. First, a pulsed laser light source is injected into the nonlinear material, where broadband four-wave mixing occurs, generating frequency-correlated photon pairs. Then, the wavelength selector groups the photons to configure a specified graph. Finally, multi-photon coincidence measurements are performed, and the results are directly proportional to the number of perfect matchings. The coincidence measurement output will automatically retain the states conforming to the perfect matching characteristics and automatically exclude unwanted states.

Without changing the photon source, the graph configuration of photon grouping can be easily transformed or expanded by programming the wavelength selector.

Broadband photon pairs are generated using nonlinear materials through pumping, and the photons are grouped by the wavelength selector. According to different frequencies, the broadband frequency-entangled photon pairs are grouped into several outputs to configure a given undirected graph. The multi-photon coincidence detection output corresponds to the state where there is exactly one photon at each output, so the measurement will automatically retain the multi-photon states that conform to the perfect matching characteristics and filter out unwanted states, such as multiple photons arriving at the same output port. The multi-photon coincidence count will be directly proportional to the number of perfect matchings.

This invention configures the connections of a specified graph through the wavelength selector, with each vertex of the graph corresponding to an output port of the wavelength selector, and each edge of the graph corresponding to a pair of frequency-correlated photons output from the two ports corresponding to the vertices of the edge.

The key to this invention is utilizing the high-dimensional characteristics of frequency degrees of freedom. The different frequency components of a single broadband biphoton source are grouped to configure the specified graph. Multi-photon coincidence measurements are then used to automatically retain the multi-photon states that conform to the perfect matching characteristics, ensuring exactly one photon at each output port, while filtering out unwanted states like multiple photons at the same output. The multi-photon coincidence count is directly proportional to the number of perfect matchings. This invention provides a new optical method for solving the number of perfect matchings in graphs, featuring high stability, strong scalability, and flexible configuration.

Advantages of this invention:

The solution utilizes the frequency degrees of freedom of broadband photon generation, allowing various photon grouping configurations with just one biphoton source.

The graph configuration is completed by the wavelength selector, making the process flexible and convenient.

Due to the frequency difference of the multi-photon terms, this method avoids destructive interference and does not require consideration of photon indistinguishability.

This invention presents an optical perfect matching solver based on frequency grouping and multi-photon coincidence detection, capable of measuring the number and distribution of perfect matchings in a specified graph. It features high stability, strong scalability, and flexible configuration. The distribution of perfect matchings is related to the graph's density and connectivity. By combining the sampling results of this distribution with classical random search algorithms, it can be applied to solve problems such as dense subgraph identification and Boolean satisfiability, offering significant advantages over uniformly distributed random searches.

### BRIEF DESCRIPTION OF FIGURES

FIG. 1 shows an experimental setup of the optical perfect matching solver based on frequency grouping and multi-photon coincidence measurement according to this invention.

FIGS. 2 and 3 show the 6-vertex graph given in Example 1 (described in the following section), along with the theoretical and experimental four-photon correlation distributions, respectively.

FIGS. 4 and 5 are the four-photon coincidence distribution of the 8 vertex graphs given in Example 2 and the corresponding theoretical and experimental results, respectively.

FIGS. 6 and 7 are the four-photon coincidence distribution of the 10 vertex plots given in Example 3 and the corresponding theoretical and experimental results, respectively.

### DESCRIPTION OF EMBODIMENTS

The following is a detailed description of the experimental setup. The entire setup is divided into three regions sequentially. Region I is the broadband biphoton source section, which includes a laser, filters, a polarization controller, and a nonlinear material section for photon generation, with the nonlinear material being a silicon waveguide as an example. Region II is the frequency grouping section, which includes filters and a wavelength selector. Region III is the coincidence detection section, which includes a polarization controller, single-photon detectors, and a coincidence counting logic circuit.

In the experimental setup illustrated in Error! Reference source not found., each unit is labeled, and the experiment is divided into three functional regions: I, II, and III.
Region I: The broadband biphoton source section. The pulsed laser used for pumping (1) passes through a filter (2) to remove stray light. The pump laser is then controlled for polarization by a polarization controller (3) before being coupled into the silicon waveguide (4). Within the silicon waveguide, the pump laser undergoes spontaneous four-wave mixing, producing broadband frequency-correlated photon pairs.
Region II: The frequency grouping section. The pump light and broadband photon pairs are coupled out of the chip. The pump light is filtered out by a subsequent filter (5), while the broadband photon pairs enter the wavelength selector (6) for frequency grouping. According to the given graph, the frequency-grouped outputs are directed to different ports, where each port represents a vertex of the graph, and each frequency-correlated photon pair represents an edge of the graph.
Region III: The coincidence detection section. The grouped photons pass through a polarization controller (7) for polarization optimization before entering the single-photon detectors (8). In the single-photon detectors, the optical signals are converted into electrical signals and sent to the coincidence counting logic circuit (9) to obtain the coincidence count distribution. The coincidence count distribution is directly proportional to the perfect matching count, such as the four-photon coincidence count distribution corresponding to the perfect matching distribution of 4-vertex subgraphs in the given graph.

The broadband biphoton source is generated by pumping a nonlinear material with a pulsed laser, where the nonlinear material may include crystals (such as periodically poled lithium niobate, periodically poled potassium titanyl phosphate, etc.) and on-chip waveguides made from materials like lithium niobate, silicon, or silicon nitride. The wavelength selector, consisting of a grating and spatial light modulator, can combine arbitrary frequency components of the input light into specified output ports. The multiphoton coincidence detection system, comprising single-photon detection channels and a coincidence counting logic circuit board, is used to measure multiphoton coincidence counts and distributions.

In the following Examples 1-3, the nonlinear material selected is a silicon-based waveguide, and a pulsed laser with a repetition rate of 60 MHz and a central frequency of 193.700 THz (wavelength 1547.72 nm) is used as the pump light. The wavelength selector used is the Waveshaper 16000A, which operates at frequencies ranging from 191.1 THz to 196.46 THz (corresponding to wavelengths from 1526.0 nm to 1568.7 nm), with a frequency setting precision of ±2.5 GHz and a bandwidth setting precision of ±5 GHz. The wavelength selector configures the connections of the specified graph, where each vertex of the graph corresponds to an output port of the wavelength selector, and each edge corresponds to a pair of frequency-correlated photons emitted from the two output ports associated with the vertices (e.g., a 10-vertex graph with 20 edges corresponds to 20 pairs of operating frequency channels and 10 output ports). Within the wavelength selector, each frequency channel is set to a width of 60 GHz with a gap of 40 GHz between adjacent channels, and the frequency channels are numbered. For example, frequency channel 1 corresponds to 193.870 THz to 193.930 THz, and its associated channel-1 corresponds to 193.470 THz to 193.530 THz.

Frequency channel 2 corresponds to 193.970 THz to 194.030 THz, with its associated channel-1 corresponding to 193.370 THz to 193.430 THz, and so on. Each pair of associated channels is symmetrically distributed around the pump light frequency.

After setting up the output of each frequency channel in the Wavemanage software, the photons entering the wavelength selector are grouped and transmitted to the designated output ports based on their frequency components. Once the graph is configured using the wavelength selector, multiphoton coincidence detection is performed at the output ports, and the detected multiphoton coincidence distribution is proportional to the graph's perfect matching number. The multiphoton coincidence detection system is used to record two or more incident particles with time correlation, particularly in optical measurement tests and quantum correlation research experiments.

The multiphoton coincidence counting system uses electronic methods and single-photon detectors to detect time-correlated photons, with the detection results uploaded to upper-level software via USB or other interfaces for processing. The system is generally easy to operate and is suitable for various scientific research platforms that require coincidence counting. The multiphoton coincidence counting device employs a multi-phase clock Time-to-Digital Converter (TDC) and a digital window comparator to perform time stamping and event coincidence detection for pulses across each channel in parallel, with real-time filtering of the coincidence results to reduce the burden of subsequent data transmission, storage, and analysis. Most of the design can be implemented within a single FPGA, supporting two-dimensional coincidence detection based on time and channel. It can accommodate hundreds of channels, offering excellent compatibility and scalability.

Three selective detail implementations of the invention are described below.

### Example 1

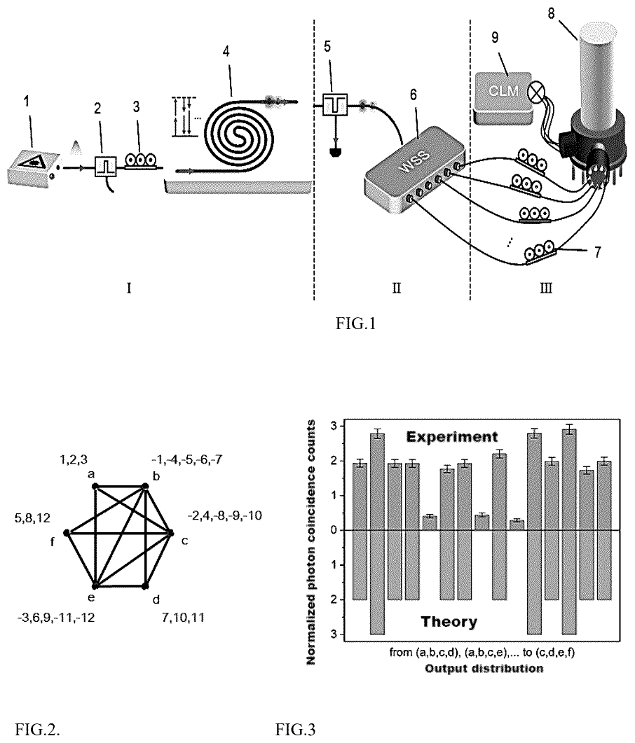

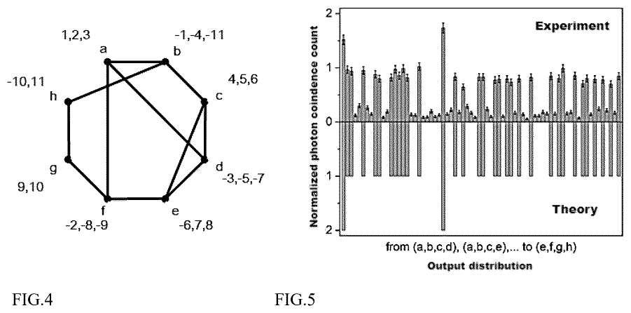

FIG. 2 shows a given 6-vertex graph. The wavelength selector is configured according to the labeled scheme, such as Frequency Channels 1, 2, and 3 outputting from port a. Four-photon coincidence counting is performed at the 6 outputs, with the distribution shown in FIG. 3. The distribution corresponds to the perfect matching count distribution of all 4-vertex subgraphs in the 6-vertex graph, with an experimental-to-theoretical fidelity of 99.48%. Note that the theoretical results are obtained by enumerating the number of perfect matchings in the subgraph with four vertices.

### Example 2

FIG. 4 shows a given 8-vertex graph. The wavelength selector is configured according to the labeled scheme. Four-photon coincidence counting is performed at the 8 outputs, with the distribution shown in FIG. 5. The distribution corresponds to the perfect matching count distribution of all 4-vertex subgraphs in the 8-vertex graph, with an experimental-to-theoretical fidelity of 97.68%. Note that the theoretical results are obtained by enumerating the number of perfect matchings in the subgraph with four vertices.

### Example 3

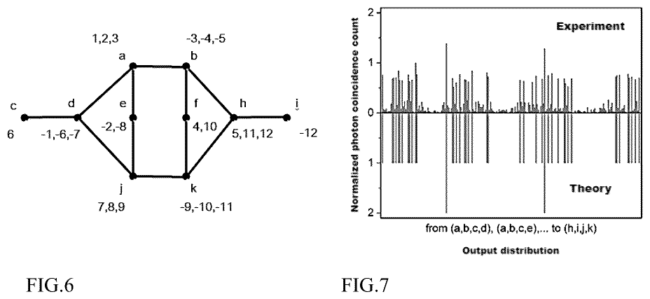

FIG. 6 shows a given 10-vertex graph. The wavelength selector is configured according to the labeled scheme. Four-photon coincidence counting is performed at the 10 outputs, with the distribution shown in FIG. 7. The distribution corresponds to the perfect matching count distribution of all 4-vertex subgraphs in the 10-vertex graph, with an experimental-to-theoretical fidelity of 95.27%. Note that the theoretical results are obtained by enumerating the number of perfect matchings in the subgraph with four vertices.

Additional remarks: Although the embodiments of the invention have been shown and described above, it is understood that these embodiments are exemplary and should not be construed as limiting the invention. Those skilled in the art may make variations, modifications, substitutions, and changes within the scope of the invention without departing from the principles and spirit of the invention.

1. An optical perfect matching solver based on frequency grouping and multi-photon coincidence measurement, comprising:
a broadband biphoton source, a wavelength selector, and a multi-photon coincidence detection system;
the broadband biphoton source is generated by pumping pulsed laser light into a nonlinear material with broadband phase matching;
the nonlinear material comprises crystals, on-chip waveguides made of lithium niobate, silicon, or silicon nitride materials;
the wavelength selector comprises a grating and a spatial light modulator, capable of combining arbitrary frequency components of the input light into a designated output port;
the multi-photon coincidence detection system consists of single-photon detection channels and a coincidence counting logic circuit board for measuring multi-photon coincidence counts and distributions;
the broadband biphoton source uses the nonlinear material to generate broadband photon pairs: first, the pulsed laser light source is injected into the nonlinear material, where a broadband four-wave mixing effect occurs, generating broadband frequency-correlated photon pairs; then, the wavelength selector groups the photons, by grouping the broadband frequency-entangled photon pairs according to different frequencies into several outputs, configured into a specified graph; finally, multi-photon coincidence measurements are performed, and the results are directly proportional to the number of perfect matchings.

2. The optical perfect matching solver based on frequency grouping and multi-photon coincidence measurement according to claim 1, characterized in that, without changing the photon source, the graph configuration of the photon grouping is transformed or expanded by programming the wavelength selector.

3. The optical perfect matching solver based on frequency grouping and multi-photon coincidence measurement according to claim 2, characterized in that
broadband photon pairs are generated using the nonlinear material, and the photons are grouped by the wavelength selector,
wherein the broadband frequency-entangled photon pairs are grouped into several outputs according to different frequencies to configure the given graph;
then, each output is connected to a single-photon detector, and
the output coincidence measurements will automatically retain the state that matches the perfect matching characteristic and automatically exclude unwanted states;
the multi-photon coincidence detection at all outputs will yield a multi-photon number distribution proportional to the number of perfect matchings.

4. The optical perfect matching solver based on frequency grouping and multi-photon coincidence measurement according to claim 1, characterized in that
the biphoton source is provided in the waveguide optical path, where the photon source includes microring resonators and helical waveguides, in which broadband spontaneous four-wave mixing or spontaneous parametric down-conversion occurs, generating broadband biphotons;
the waveguide substrate material including both third-order nonlinear materials, including silicon (Si), silicon nitride (SiN), and gallium arsenide (GaAs), and second-order nonlinear materials, including lithium niobate (LiNO3), or any material system capable of being processed into waveguides.

5. The optical perfect matching solver based on frequency grouping and multi-photon coincidence measurement according to claim 1, characterized in that the given graph configuration, representing the connection relationships in the graph, is set by the wavelength selector, where each vertex of the graph corresponds to an output port of the wavelength selector, and each edge of the graph corresponds to a pair of frequency-correlated photons outputted from two different vertices'corresponding output ports.

6. The optical perfect matching solver based on frequency grouping and multi-photon coincidence measurement according to claim 1, characterized in that after the graph is configured by the wavelength selector, multi-photon coincidence detection is performed on the output ports, and the distribution detected will be proportional to the number of perfect matchings in the specified graph.
